(19) United States
(12) Patent Application Publication
(10) Pub. No.: US 2015/0314573 A1
(43) Pub. Date: Nov. 5, 2015

(54) TRANSPARENT PLATE AND DISPLAY DEVICE USING IT

(71) Applicant: ASAHI GLASS COMPANY, LIMITED, Tokyo (JP)

(72) Inventor: Satoshi NIIYAMA, Tokyo (JP)

(73) Assignee: ASAHI GLASS COMPANY, LIMITED, Tokyo (JP)

(21) Appl. No.: 14/748,696

(22) Filed: Jun. 24, 2015

Related U.S. Application Data
(63) Continuation of application No. PCT/JP2014/052698, filed on Feb. 5, 2014.

(30) Foreign Application Priority Data
Feb. 6, 2013 (JP) 2013-021662

(51) Int. Cl. B32B 17/06

(52) U.S. Cl. CPC B32B 17/064; B32B 2307/412; B32B 2457/20

(57) ABSTRACT

To provide a transparent plate capable of effectively protecting a display surface even if in a display device, there is a substantial difference in level from the upper surface of a frame to the display surface, and a display device using it. The transparent plate of the present invention comprises a transparent first substrate, a transparent second substrate formed on the first substrate and having a shape smaller than the first substrate, an adhesive layer formed on the second substrate, and a protective film formed on the adhesive layer.

### TECHNICAL FIELD

The present invention relates to a transparent plate to be used for a display device having a liquid crystal panel, a plasma display panel (hereinafter referred to as PDP), etc., and a display device using it, particularly to a transparent plate suitable for a case where there is a substantial difference in level from the upper surface of a frame to the display surface in the display device, and a display device using it.

### BACKGROUND ART

Heretofore, in order to protect a display panel of a display device having a liquid crystal panel, PDP, etc., a transparent protective member to cover the display surface (display region) of the display panel has been used. A protective member to protect a display device in such a manner has been proposed (see e.g. Patent Document 1).

Patent Document 1 discloses a transparent plate (e.g. a protective plate) having an adhesive layer formed on its surface. In the transparent plate of Patent Document 1, the adhesive layer is one to be bonded to the display surface (surface constituting an adherend) of a display panel, and the adhesive layer has a layer portion spreading along the surface of the transparent plate and a seal portion surrounding the periphery of the layer portion. The layer portion and the seal portion are formed of a transparent resin. Further, with respect to the seal portion, at least at a part of the region close to the layer portion, the thickness of the seal portion is said to be preferably thicker than the thickness of the layer portion.

### PRIOR ART DOCUMENT

### Patent Document

Patent Document 1: WO2011/148990

### DISCLOSURE OF INVENTION

### Technical Problem

At present, a commercial display device usually has a frame formed of e.g. a metal or a resin, along the outer edge on the display surface side of a display panel. Therefore, in such a commercial display device, at the time of bonding the transparent plate of Patent Document 1 to the display region of the display device for the purpose of protecting the display surface (display region), it is necessary to decide the thicknesses of the seal portion and the layer portion by taking the thickness of the above frame into consideration.

However, in the transparent plate of Patent Document 1, the adhesive layer is formed of a transparent resin, and the thickness cannot be made so thick. Therefore, there is a problem that the transparent plate of Patent Document 1 may not be useful in a case where the thickness of the frame is thick, so that the distance from the upper surface of the frame to the display surface is large.

Further, as the adhesive layer is made of a transparent resin, in a case where the thickness is thick, it becomes difficult to make the thickness uniform, and the thickness tends to be non-uniform. If the thickness becomes non-uniform, there will be problems especially in a liquid crystal display device, such that the pressure to a liquid crystal panel at the time of bonding, tends to be non-uniform, and display unevenness is likely to be caused e.g. as the liquid crystal panel is pressed, whereby the image quality tends to deteriorate.

It is an object of the present invention to solve such problems in the prior art and to provide a transparent plate capable of effectively protecting a display surface even if the difference in level from the upper surface of the frame to the display surface in a display device is large, and a display device using such a transparent plate.

### Solution to Problem

In order to accomplish the above object, the present invention provides a transparent plate comprising a transparent first substrate, a transparent second substrate formed on the first substrate and having a shape smaller than the first substrate, an adhesive layer formed on the second substrate, and a protective film formed on the adhesive layer.

The second substrate is preferably formed on the first substrate via a resin layer or an adhesive layer.

Further, the first substrate and the second substrate may be directly bonded to each other. The first substrate and the second substrate may be integral with each other.

For example, the shapes of the first substrate and the second substrate are preferably rectangular. In such a case, it is preferred that the centers of the first substrate and the second substrate match each other.

On the surface of the first substrate, a light shielding portion is preferably formed along the periphery of a region where the second substrate is formed.

Further, the first substrate is preferably a chemically tempered glass plate. The height from the surface of the first substrate to the surface of the adhesive layer is preferably from 0.8 to 2.3 mm.

The thickness of the second substrate is preferably from 0.5 to 1.5 mm.

Further, the display device of the present invention preferably comprises a display panel and the above transparent plate, so that the adhesive layer of the transparent plate having the protective film peeled off, is bonded to a display surface of the display panel.

### Advantageous Effects of Invention

According to the transparent plate of the present invention and the display device using it, it is possible to effectively protect a display surface even if the difference in level between a frame, etc. and the display surface in a display device is large.

### BRIEF DESCRIPTION OF DRAWINGS

FIG. 1(a) is a schematic cross-sectional view showing an example of the transparent plate in an embodiment of the present invention, and FIG. 1(b) is a schematic plan view showing the transparent plate in the embodiment of the present invention.

FIG. 2(a) is a schematic cross-sectional view showing an example of the application mode of the transparent plate shown in FIG. 1(a) to a display device, and FIG. 2(b) is a schematic plan view showing, as enlarged, the main part of the display device to which the transparent plate is to be bonded.

FIG. 3(a) is a schematic cross-sectional view showing another example of the transparent plate in an embodiment of the present invention, and FIG. 3(b) is a schematic cross-sectional view showing still another example of the transparent plate in an embodiment of the present invention.

FIGS. 4(a) to 4(f) are schematic cross-sectional views showing stepwisely a process for producing the transparent plate shown in FIG. 1(a).

FIG. 5 is a schematic cross-sectional view illustrating another process for producing the transparent plate shown in FIG. 1(a).

FIGS. 6(a) to 6(d) are schematic cross-sectional views showing stepwisely a process for producing a double-sided adhesive layer-equipped transparent member to be used for the process for producing the transparent plate shown in FIG. 5.

FIGS. 7(a) to 7(d) are schematic cross-sectional views showing stepwisely another process for producing a double-sided adhesive layer-equipped transparent member to be used for the process for producing the transparent plate shown in FIG. 5.

### DESCRIPTION OF EMBODIMENTS

Now, based on preferred embodiments shown in the accompanying drawings, the transparent plate of the present invention will be described in detail.

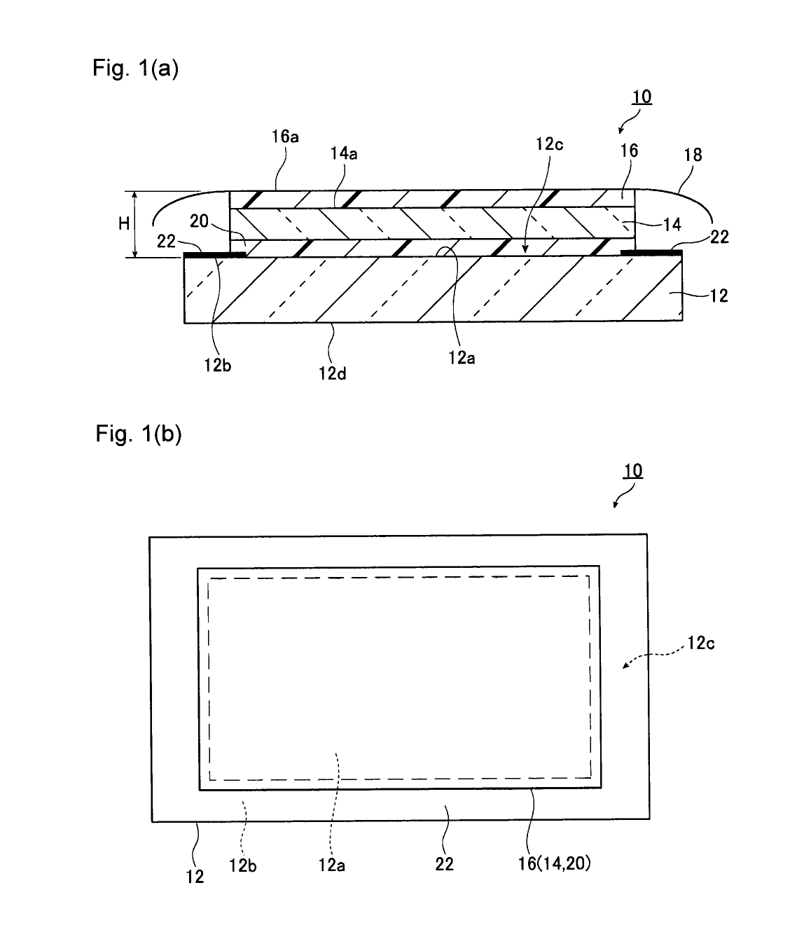

FIG. 1(a) is a schematic cross-sectional view showing an example of the transparent plate in an embodiment of the present invention, and FIG. 1(b) is a schematic plan view showing the transparent plate in the embodiment of the present invention.

Here, “transparent” in this specification means such a state that even after a transparent plate and a display surface of a display panel are bonded via an adhesive layer without a void space, whole or part of at least a display image of the display panel is visible through the transparent plate without receiving optical distortion. Accordingly, a transparent plate can be regarded as “transparent” so long as a display image on a display panel is visible through the transparent plate without optical distortion, even if part of light which enters into the transparent plate from the display panel is absorbed or reflected by the transparent plate, or even if the visible light transmittance of the transparent plate is low due to e.g. a change in the optical phase.

The transparent plate 10 shown in FIGS. 1(a) and 1(b) is one to be bonded to a display surface of a display device and to be used for protection of the display surface (display region) of the display device. The transparent plate 10 has a transparent first substrate 12, a transparent second substrate 14, an adhesive layer 16, a protective film 18, a resin layer 20 and a light-shielding portion 22. The adhesive layer 16 and the resin layer 20 are transparent like the first substrate 12 and the second substrate 14. In order to prevent multiple reflection, etc. and obtain a good image in a display device having the transparent plate 10 bonded, it is preferred that the first substrate 12, the second substrate 14, the adhesive layer 16 and the resin layer 20 have a small difference in refractive index. A sensor for detecting an input position made of a transparent conductive film may be provided on the surface, at the first substrate 12 side, of the second substrate 14. The sensor may be provided, for example, in a lattice pattern of plurality extending, respectively, in a first direction and in a second direction orthogonal to the first direction.

Here, the transparent plate 10 is bonded to the display device by peeling the protective film 18 off. This display device may be in a state of a completed product or a semi-completed product of a liquid crystal display device so called a LCD module (hereinafter referred to as LCD). The transparent plate 10 may be bonded to the completed product or to the semi-completed product.

Now, an application mode of the transparent plate 10 will be specifically described with reference to a case where it is bonded to a LCD module 100 as a display device.

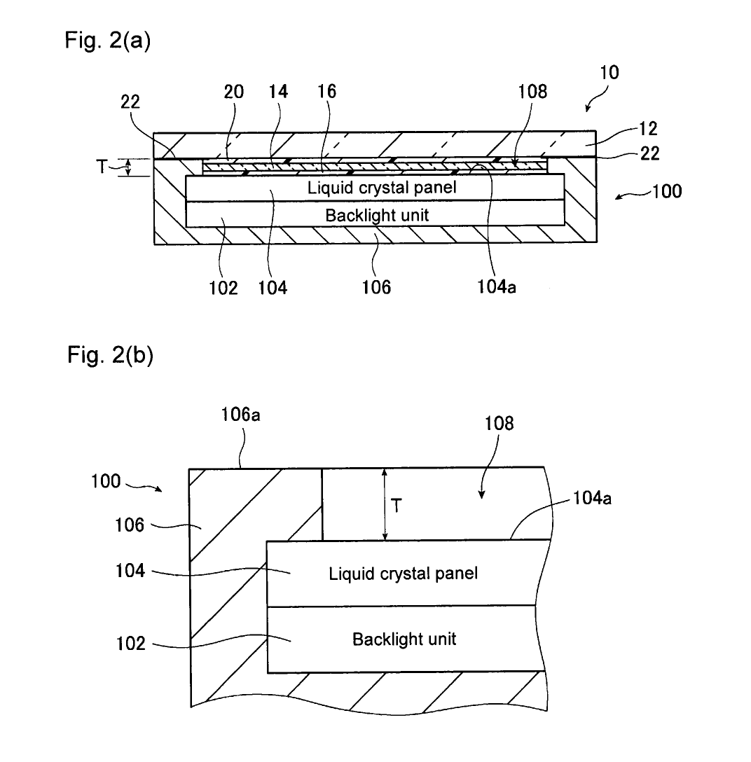

FIG. 2(a) is a schematic cross-sectional view showing an example of the application mode of the transparent plate shown in FIG. 1(a) to a display device, and FIG. 2(b) is a schematic plan view showing, as enlarged, the main part of the display device to which the transparent plate is to be bonded.

As shown in FIG. 2(a), the LCD module 100 has a liquid crystal panel 104 mounted on a backlight unit 102, and such a backlight unit 102 and a liquid crystal panel 104 are accommodated in a frame 106 made of a metal. This frame 106 has an opening 108, and the liquid crystal panel 104 is disposed at this opening 108 side. The region corresponding to the opening 108, of the liquid crystal panel 104, will be referred to as a display surface 104a.

Here, constructions of the backlight unit 102 and the liquid crystal panel 104 are not particularly limited, and conventional ones may be used.

As shown in FIG. 2(b), at the opening 108 of the frame 106, there is a difference in level from the display surface 104a of the liquid crystal panel 104 to the end surface 160a on the upper surface side of the frame 106, and the length of the difference in level is T. The distance T of this difference in level is from about 0.8 to 2.3 mm. The portion at which this difference in level is formed, will be referred to also as a stepped portion.

As shown in FIG. 2(a), the transparent plate 10 is disposed to fit in the opening 108 of the frame 106, and the adhesive layer 16 is bonded to the display surface 104a of the liquid crystal panel 104. Thus, from the display surface 104a of the LCD module 100 to the end surface 106a of the frame 106, is covered by the first substrate 12. This first substrate 12 functions as a protective member for the display surface 104a of the LCD module 100.

Here, the display device is not limited to the above LCD module 100. The display device may, for example, be one having an organic EL panel, PDP or an electronic ink type panel.

In the transparent plate 10, the second substrate 14 is formed on the first substrate 12 via a resin layer 20. In the first substrate 12, the region where the second substrate 14 is formed, will be referred to as a disposition region 12a.

As shown in FIG. 1(b), the shapes of the first substrate 12 and the second substrate 14 are, for example, rectangular, and the second substrate 14 is smaller in its shape. The second substrate 14 is disposed, for example, so that the center matches to the first substrate 12. By forming the second substrate 14 smaller in its shape than the first substrate 12, on the first substrate 12, a stepped portion is formed at the periphery of the first substrate 12. On the surface 12c of the first substrate 12, a light-shielding portion 22 is formed along the peripheral region 12b at the periphery of the disposition region 12a.

As shown in FIG. 1(a), an adhesive layer 16 is formed on the surface 14a at the side opposite to the first substrate 12, of the second substrate 14.

On the surface 16a of the adhesive layer 16, a protective film 18 to cover the entire surface of the first substrate 12, is formed so that it can be peeled off. At the time of boding the transparent plate 10 to a display device, the protective film 18 will be peeled off. The protective film 18 may be one which at least covers the adhesive layer 16, but it is preferred to use a protective film 18 slightly larger than the first substrate 12, so that the end portion of the protective film 18 may be easily pinched at the time of peeling off.

The first substrate 12 is one to protect the display surface (display region) of a display device. As such a first substrate 12, a glass plate or a transparent resin plate may, for example, be used. A glass plate is most preferred, not only from the viewpoint of the high transparency against emitted light or reflected light from a display panel, but also from the viewpoint of the light resistance, low birefringence, high planar precision, surface scratch resistance and high mechanical strength.

The glass plate may, for example, be a soda lime glass plate, and a high transmission glass having a lower iron content and being less bluish (so-called also as white plate glass) is more preferred. In order to increase safety, a tempered glass plate may be used as the surface material. Especially in a case where a thin glass plate is to be used, it is preferred to use a chemically tempered glass plate.

As a transparent resin plate, in a case where the display device is LCD, an acrylic resin (polymethyl methacrylate), a triacetyl cellulose (TAC resin) or a hydrocarbon resin may, for example, be used. Further, for other than LCD, a polycarbonate resin may, for example, be used.

From the viewpoint of the mechanical strength and transparency, the thickness of the first substrate 12 is preferably from 0.5 to 25 mm in the case of a glass plate. In an application to a television receiver, a PC display or the like to be used indoor, from 1 to 6 mm is preferred with a view to reducing the weight of the display device, and in an application to a public display to be installed outdoor, from 3 to 20 mm is preferred. In the case of using a chemically tempered glass, the thickness of the glass plate is preferably from about 0.5 to 1.5 mm from the viewpoint of the strength. Further, in the case of a transparent resin plate, the thickness of the first substrate 12 is preferably from 2 to 10 mm.

In the first substrate 12, in order to improve the interfacial adhesive force with the resin layer 20, surface treatment may be applied by e.g. a method of treating with a silane coupling agent, or a method of forming a thin film of silicon oxide by oxidative flame by means of a flame burner.

The shape and size of the first substrate 12 are suitably determined to meet the shape of the display device. With a display device, the shape is usually rectangular such as oblong, and therefore, in such a case, the shape of the first substrate 12 is rectangular. From the viewpoint of outlook, the size of the first substrate 12 is preferably made to match the shape of the display device. Depending upon the shape of the display device, it is also possible to employ a first substrate 12 with a shape having a curve in its shape, to cover the entire display surface of the display panel.

To the first substrate 12, in order to increase the contrast of a display image, an anti-reflection layer may be provided at the rear surface 12d. Further, depending upon the purpose, part or whole of the first substrate 12 may be colored; part or whole of the rear surface 12d of the first substrate 12 may be made to be ground-glass to scatter light; or fine irregularities, etc. may be formed on part or whole of the rear surface 12d of the first substrate 12 to refract or reflect transmitted light. Or, a colored film, a light-scattering film, a light-refracting film, a light-reflecting film, etc. may be bonded to part or whole of the surface of the first substrate 12.

The second substrate 14 is one to serve as a substitute for part of the thickness of the adhesive layer 16 to make the apparent thickness of the adhesive layer 16 to be thick. This is because, if the adhesive layer 16 is formed by a single body so that the thickness exceeds 1 mm, it tends to be difficult to make the thickness uniform. By the second substrate 14, it is possible to make the apparent height of the adhesive layer 16 to be high.

The shape and size of the second substrate 14 are made to be approximately the same shape and size as the opening of the frame at the display surface side of the display device. In a case where the shape of the frame and the shape of the opening are the same, and the shape of the frame and the opening match at their centers, the second substrate 14 has the same shape as the first substrate 12 and is disposed so that its center matches to the first substrate 12.

The transparent plate of the present invention is preferably used for a display device wherein the upper surface of a frame to be formed along the periphery on the display surface side of a display panel of the display device is higher than the display surface, so that there is a stepped portion having e.g. a height H between the upper surface of the frame and the display surface. Therefore, it is preferred that the second substrate 14 of the transparent plate 10 has a suitable thickness depending upon the above stepped portion (for example, a suitable thickness to supplement the thickness of the stepped portion in consideration of the thicknesses of the adhesive layer 16 and the resin layer 20), and the stepped portion formed along the periphery of the first substrate 12 by providing the second substrate 14 smaller in the shape than the first substrate 12, on the first substrate 12, and the stepped portion formed between the end surface 106a of the upper surface of the frame 106 and the display surface 104a, are disposed to match each other.

The second substrate 14 is transparent and is constituted by the same material as the above-described first substrate 12, and therefore, its detailed description will be omitted. The combination of the first substrate 12 and the second substrate 14 is not particularly limited so long as it presents no adverse influence to a display image of the display device. Here, the thickness of the second substrate 14 is from about 0.5 to 1.5 mm.

The adhesive layer 16 is one to bond the transparent plate 10 to a display surface of a display device, at the time of bonding the transparent plate 10 to the display device. To the adhesive layer 16, a protective film 18 is peelably formed on its surface 16a.

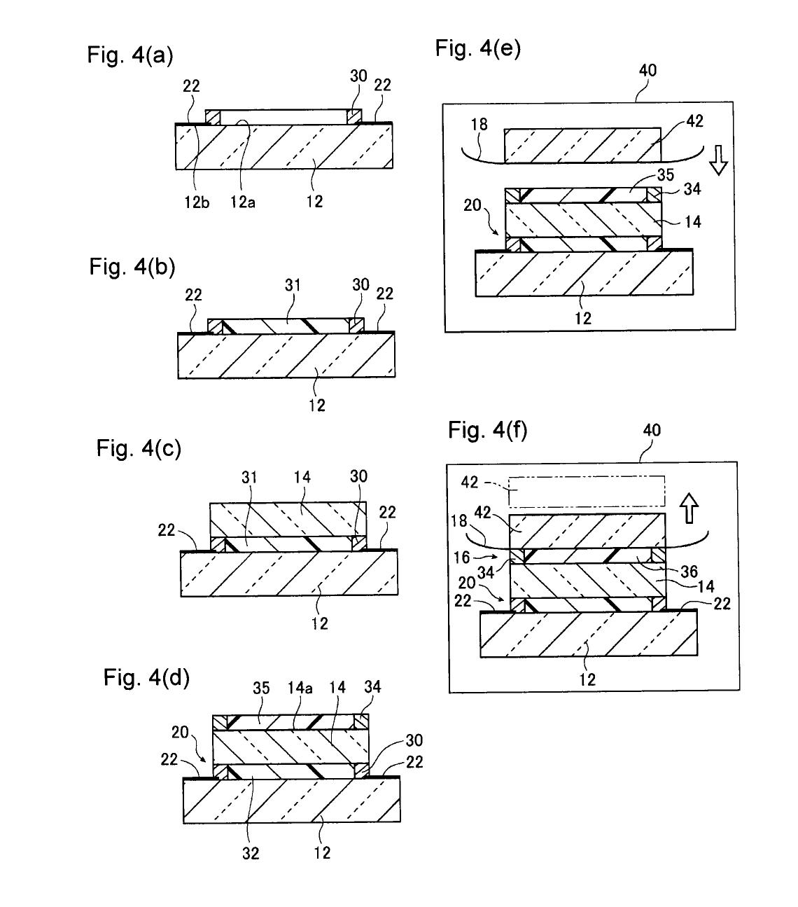

The adhesive layer 16 is constituted, for example, by a seal portion 34 (not shown in FIG. 1(a), see FIG. 4(f)) formed in a frame shape along the periphery of the surface 14a of the second substrate 14, and a layer portion 36 (not shown in FIG. 1(a), see FIG. 4(f)) having adhesive properties, formed in a region surrounded by such a seal portion 34. In the adhesive layer 16, each of the seal portion 34 and the layer portion 36 plays a role for bonding.

Here, the adhesive layer 16 may be a commercially available adhesive sheet, and in such a case, it is bonded to the surface 14a of the second substrate 14.

The layer portion 36 of the adhesive layer 16 is a layer composed of a transparent resin obtained by curing, for example, the after-described liquid curable resin composition for forming a layer portion.

The shear modulus at 25° C. of the adhesive layer 16 is preferably from 10³ to 10⁷ Pa, more preferably from 10⁴ to 10⁶ Pa. Further, 10⁴ to 10⁵ Pa is particularly preferred in order to let voids disappear in a shorter time at the time of bonding. When the shear modulus is at least 10³ Pa, the shape of the adhesive layer 16 can be maintained. Further, even in a case where the thickness of the adhesive layer 16 is relatively thick, the thickness can be maintained to be uniform by the entire adhesive layer 16, and at the time of bonding the transparent plate 10 and the display panel, voids are less likely to be formed at the interface between the display panel and the adhesive layer 16. Further, when the shear modulus is at least 10⁴ Pa, deformation of the adhesive layer 16 can easily be prevented at the time of peeling off the protective film 18. When the shear modulus is at most 10⁷ Pa, the adhesive layer 16 can exhibit good adhesive properties when bonded to a display panel. Further, the molecular mobility of the resin material forming the adhesive layer 16 is relatively high, whereby at the time of bonding the display panel and the transparent plate 10 in a reduced pressure atmosphere, followed by returning the atmosphere to the atmospheric pressure atmosphere, the volume of voids tends to be readily reduced by a pressure difference between the pressure inside of the voids (the pressure in the state of reduced pressure) and the pressure exerted to the adhesive layer 16 (the atmospheric pressure). Further, a gas in voids having the volume reduced, tends to be readily dissolved and absorbed in the adhesive layer 16.

Further, when the layer portion 36 of the adhesive layer 16 has a shear modulus at 25° C. of from 10³ to 10⁷ Pa, the pressure at the time of bonding to the liquid crystal panel will not remain in the adhesive layer, whereby there will be no adverse influence to the liquid crystal alignment in the liquid crystal panel, and it is possible to prevent deterioration of the image quality.

Further, by adjusting the elastic modulus of the seal portion 34 of the adhesive layer 16 to be larger than the elastic modulus of the layer portion 36, it is possible to effectively prevent deformation of the adhesive layer 16 at the periphery of the adhesive layer 16 where the pressure may sometimes be concentrated at the time of bonding the transparent plate 10 to the display panel 104. Further, it is possible to prevent a non-uniform stress from remaining in the adhesive layer 16 after the bonding, and without presenting an adverse influence to the liquid crystal alignment at the periphery in the liquid crystal panel, it is possible to prevent deterioration of the image quality.

The thickness of the adhesive layer 16 is preferably from about 0.1 to 0.8 mm. When the thickness of the adhesive layer 16 is from about 0.1 to 0.8 mm, an adhesive layer 16 having a uniform thickness can easily be formed, and voids are less likely to remain in the adhesive layer 16. Besides, a shock may be reduced at the time of bonding to a liquid crystal panel, and local pressing of the display surface can be avoided, whereby it is possible to prevent display irregularities from occurring.

Here, the thickness of the adhesive layer 16 is the distance from the surface 14a in contact with the second substrate 14 to the surface 16a of the adhesive layer 16 to which the protective film 18 is to be bonded. When the thickness is within the above range, even if a foreign matter not exceeding the thickness of the adhesive layer 16 is included between the display panel and the transparent plate 10, the thickness of the adhesive layer 16 may not be substantially changed, and there will be little influence to the light transmission performance.

The method for adjusting the thickness of the adhesive layer 16 may, for example, be a method of adjusting the amount of the liquid curable resin composition for forming a layer portion (hereinafter referred to as the first composition) to be supplied to the surface 14a of the second substrate 14, at the same time as adjusting the thickness of the seal portion 34.

Further, the seal portion 34 is one composed of a transparent resin formed by applying the after-described liquid curable resin composition for forming a seal portion (hereinafter referred to as the second composition), followed by curing. The width of the seal portion 34 is preferably from 0.5 to 2 mm, more preferably from 0.8 to 1.6 mm. Further, the thickness of the seal portion 34 is preferably substantially equal to the average thickness of the layer portion 36 excluding the region where the seal portion 34 and the layer portion 36 are adjacent to each other, or thicker by from 0.005 to 0.05 mm, more preferably thicker by from 0.01 to 0.03 mm, than the average thickness of the layer portion 36.

The shear modulus at 25° C. of the seal portion 34 or the layer portion 36 is one measured as follows.

Using a rheometer (Modular Rheometer PhysicaMCR-301, manufactured by Anton Paar GmbH), the space between a measuring spindle and a light transmitting plate is adjusted to be the same as the average thickness of the seal portion 34 or the layer portion 36, then an uncured first composition or an uncured second composition is disposed in the space, and while applying heat or light required for curing to the uncured first composition or to the uncured second composition, the shear modulus during the curing process is measured, whereby a measured value under prescribed curing conditions is taken as the shear modulus of the seal portion 24 or the layer portion 36.

The shear modulus at 25° C. of the seal portion 34 is preferably larger than the shear modulus at 25° C. of the layer portion 36. By adjusting the shear modulus of the seal portion 34 to be larger than the shear modulus of the layer portion 36, it is possible to effectively prevent deformation of the adhesive layer 16 at the periphery of the adhesive layer 16 where the pressure is likely to be concentrated at the time of bonding.

The first composition and the second composition may be photo-curable resin compositions or thermosetting resin compositions. The first composition is preferably a photo-curable resin composition comprising a curable compound and a photopolymerization initiator, from such a viewpoint that curing can be done at a low temperature and the curing speed is high. The first composition is preferably a photo-curable resin composition for forming a layer portion disclosed in Patent Document 1. Further, the second composition is preferably a photo-curable resin composition for forming a seal portion disclosed in Patent Document 1.

The resin layer 20 is one to bond (or adhere) the first substrate 12 and the second substrate 14. The resin layer 20 is constituted by e.g. a seal portion 30 (not shown in FIG. 1(a), see FIG. 4(b)) formed in a frame shape along the periphery of the disposition region 12a of the first substrate 12, and a layer portion 32 (not shown in FIG. 1(a), see FIG. 4(b)) formed in a region surrounded by such a seal portion 30. In the resin layer 20, each of the seal portion 30 and the layer portion 32 plays a role for bonding to the first substrate 12.

The seal portion 30 is composed, for example, of the same one as the seal portion 34 of the adhesive layer 16, and therefore, its detailed description will be omitted.

The layer portion 32 is composed, for example, of the same one as the layer portion 36 of the adhesive layer 16, and therefore, its detailed description will be omitted.

Here, the resin layer 20 is not particularly limited so long as it is capable of bonding the first substrate 12 and the second substrate 14 and is transparent, and a commercially available adhesive sheet may be employed.

The thickness of the resin layer 20 is preferably at most 0.6 mm, more preferably from about 0.1 to 0.4 mm.

As between the adhesive layer 16 and the resin layer 20, it is preferred to make the adhesive layer 16 thicker. Because the adhesive layer 16 is required to reduce a shock at the time of bonding to the display panel 104 and to prevent display irregularities from occurring, while the resin layer 20 is simply required to bond the first substrate 12 and the second substrate 14. Further, with respect to the shear modulus at 25° C., as between the adhesive layer 16 and the resin layer 20, the adhesive layer 16 preferably has a lower shear modulus.

The light-shielding portion 22 is one to shield wiring members, etc. connected to a display panel, other than the after-described display surface (display region) of the display panel, so that they cannot be seen from the rear surface 12d side of the first substrate 12. The light-shielding portion 22 is formed in a frame shape. Further, the light-shielding portion 22 may be formed on either the front surface 12c or the rear surface 12d of the first substrate 12. With a view to reducing parallax between the light-shielding portion 22 and the display region, it should better be formed on the front surface 12c. In a case where the first substrate 12 is a glass plate, it is preferred to form the light-shielding portion 22 by using ceramic printing containing a black pigment, whereby the light-shielding properties will be high.

In the case of such a construction that wiring members, etc. of the display panel cannot be seen from the side of observing the display panel, or in a case where they are shielded by other member such as a frame or housing of the display device, or in a case where an adherend other than a display panel and an adhesive layer-equipped transparent plate are to be bonded, it is not necessarily required to form a light-shielding portion 22 on the first substrate 12.

In the transparent plate 10, the region (disposition region 12a) surrounded by the light-shielding portion 22 becomes a light-transmissive portion.

The protective film 18 is one to protect the adhesive layer 16.

The protective film 18 is required to be peelable from the adhesive layer 16 and required to be bonded to a support plate 42 in the production process as described later. Therefore, as the protective film 18, the surface in contact with the adhesive layer 16 is preferably a base material film having relatively low adhesive properties, made of e.g. polyethylene, polypropylene or a fluorinated resin. The surface in contact with the support plate 42, of the protective film 18, is preferably made to be an adhesive surface, and such an adhesive surface is preferably composed of a self-adhesive layer formed on the base material film.

In a case where a relatively flexible film of e.g. polyethylene or polypropylene is used, the thickness of the protective film 18 is preferably from 0.03 to 0.2 mm, more preferably from 0.05 to 0.1 mm. When the thickness of the protective film 18 is at least 0.03 mm, it is possible to prevent deformation of the protective film 18 at the time of peeling the protective film 18 from the adhesive layer 16. When the thickness of the protective film 18 is at most 0.2 mm, at the time of peeling, the protective film 18 tends to be readily bent so that peeling will be easy. Further, in the protective film 18, a rear surface layer may be provided on the side in contact with the adhesive layer 16 in order to make its peeling from the adhesive layer 16 easier.

As such a rear surface layer, it is preferred to use a relatively low adhesive film of e.g. polyethylene, polypropylene, a polymer blend of polypropylene and polyethylene, or a fluorinated resin. Further, in order to make peeling easy, it is also possible to apply a release agent such as silicone to the back surface layer within a range not to present an adverse influence to the adhesive layer 16.

Here, the oxygen permeation rate of the protective film 18 is preferably at most 100 cc/m²·day·atm, more preferably at most 10 cc/m²·day·atm. It is thereby possible to prevent an influence of external air to the adhesive layer 16, after this transparent plate 10 is produced until it is used for bonding to an adherend. The oxygen permeation rate of the protective film 18 is one measured by a gas permeation measuring apparatus K-315-N(complying with JIS K7126) manufactured by TRS Tsukuba Rika Seiki K.K. by using O₂ gas in an environment at a temperature of 25° C.

Otherwise, the protective film 18 may be a laminated film having a resin film laminated with a barrier layer to prevent permeation of gas. In such a case, as the resin film, a film of a polyolefin resin such as polyethylene or polypropylene, a fluorinated resin, a polyester resin such as polyethylene terephthalate (PET) or polyethylene naphthalate (PEN), or a polyamide resin such as nylon-6 or nylon-66, may be used.

The barrier layer may be composed of e.g. silicon oxide (SiO₂), aluminum oxide (Al₂O₃), silicon nitride, silicon oxynitride, aluminum oxynitride, magnesium oxide, zinc oxide, indium oxide, tin oxide, clay crystals of layered silicate, etc. It is particularly preferably composed of silicon oxide (SiO₂) and aluminum oxide (Al₂O₃).

In a case where the adhesive layer 16 is composed of a resin having a photo-curable composition cured and is formed by curing the photo-curable resin composition by irradiation with ultraviolet rays or visible light having a short wavelength through the protective film 18, the protective film 18 is required to have a sufficient transmission property to a wavelength of light irradiated in a state in contact with the adhesive layer 16. In such a case, the transmittance for ultraviolet rays (wavelength: 365 nm) of the protective film 18 is preferably at least 50%.

In the transparent plate 10 in this embodiment, by using the second substrate 14, it is possible to readily make the thickness H from the front surface 12c of the first substrate 12 to the front surface 16a of the adhesive layer 16 to be thicker than ever. The thickness H is substantially equal to the distance T of the above-mentioned difference in level and is, for example, from 0.8 to 2.3 mm. By forming such a thickness H, it becomes easy to dispose the stepped portion formed along the periphery of the first substrate 12 by providing the second substrate 14 smaller in the shape than the first substrate 12, on the first substrate 12, and the stepped portion formed between the upper surface 106a of the above frame and the display surface 104, so that they match each other.

Thus, bonding can be done without a clearance gap, even if there is such a difference in level that cannot be dealt with by a conventional technique, in a display device to be bonded. In such a case, there will be, of course, no adverse influence to a display image of the display device to which the transparent plate 10 is bonded.

Specifically, like the LCD module shown in FIGS. 2(a) and 2(b), even in a case where the difference in level (distance T) of the frame 106 is large, it is possible to bring the adhesive layer 16 to a position suitable for bonding to the display surface 104a by adjusting the thickness of the second substrate 14 without changing the thickness, etc. of the adhesive layer 16.

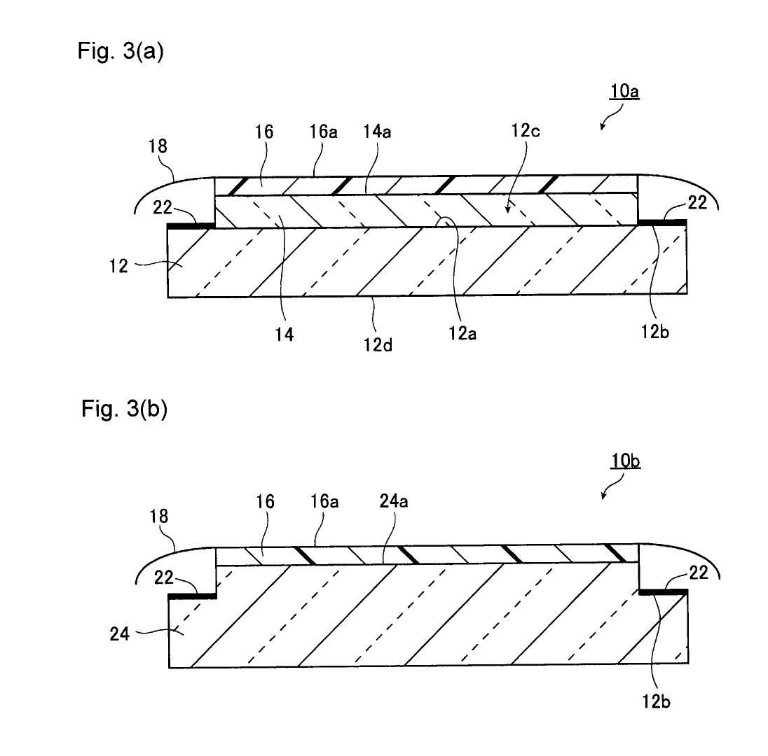

In the present invention, the transparent plate is by no means limited to the transparent plate 10 shown in FIGS. 1(a) and 1(b). For example, like the transparent plate 10a shown in FIG. 3(a), the first substrate 12 and the second substrate 14 may be directly bonded to each other.

As compared to the transparent plate 10 shown in FIGS. 1(a) and 1(b), this transparent plate 10a has the same construction as the transparent plate 10 shown in FIGS. 1(a) and 1(b) except that the first substrate 12 and the second substrate 14 are directly bonded and that the light-shielding portion 22 is formed to the end surface of the second substrate 14, and therefore, its detailed description will be omitted.

In the transparent plate 10a, the first substrate 12 and the second substrate 14 may be directly bonded, for example, by heat bonding wherein the first substrate 12 and the second substrate 14 are heated and bonded.

Further, like the transparent plate 10b shown in FIG. 3(b), the first substrate 12 and the second substrate 14 may be integrated as a transparent substrate 24. As compared to the transparent plate 10 shown in FIGS. 1(a) and 1(b), this transparent plate 10b has the same construction as the transparent plate 10 shown in FIGS. 1(a) and 1(b) except that it has the above transparent substrate 24, the adhesive layer 16 is formed on the upper surface 24a of the transparent substrate 24, and the light-shielding portion 22 is formed on the end surface 24b of the transparent substrate 24, and therefore, its detailed description will be omitted.

The transparent substrate 24 may be constituted, for example, by using the same one as the first substrate 12 and may, for example, be formed by pressing, cutting or injection molding.

Now, the process for producing the transparent plate 10 shown in FIGS. 1(a) and 1(b) will be described.

FIGS. 4(a) to 4(f) are schematic cross-sectional views showing stepwisely a process for producing the transparent plate shown in FIG. 1(a).

Firstly, as shown in FIG. 4(a), a light-shielding portion 22 is formed along the peripheral region 12b of the first substrate 12. As shown in FIG. 1(b), this light-shielding portion 22 is formed in a frame shape.

And, as shown in FIG. 4(a), in order to cover the inner edge of the light-shielding portion 22, a seal portion 30 is formed to surround the periphery of the disposition region 12a for the second substrate 14. This seal portion 30 is formed in a frame shape having a prescribed width.

The seal portion 30 may be formed, for example, by a silkscreen method, a coating method, etc. using the above-mentioned second composition. At the time when only the seal portion 30 has been formed, the seal portion 30 may be in an uncured state or in a semi-cured state. The viscosity of the second composition is preferably from 500 to 3,000 Pa·s, more preferably from 800 to 2,500 Pa·s, further preferably from 1,000 to 2,000 Pa·s. When the viscosity is at least 500 Pa·s, the shape of the uncured seal portion can be maintained for a relatively long time, and the height of the uncured seal portion 30 can sufficiently be maintained. When the viscosity is at most 3,000 Pa·s, the uncured seal portion 30 can be formed by coating.

Otherwise, in a case where the second composition is a photo-curable composition, and light is applied at the same time as coating or immediately after coating for partial curing to a semi-cured state, the viscosity of the second composition may be made to be from 5 to 500 Pa·s, and in such a case, from 10 to 100 Pa·s is preferred, from such a viewpoint that the coating speed can be increased. When the viscosity is at least 10 Pa·s, the shape after coating can be maintained and the height of the uncured seal portion can sufficiently be maintained, for a time from the coating to irradiation with light. When the viscosity is at most 100 Pa·s, the height of the uncured seal portion can sufficiently be maintained even if the coating speed is increased.

The viscosity of the first composition or the second composition is one measured by using an E-type viscometer at a temperature of 25° C.

Then, as shown in FIG. 4(b), a curable resin composition 31 for forming a layer portion (hereinafter referred to as the resin composition 31) is applied to the disposition region 12a surrounded by the seal portion 30. The seal portion 30 and the resin composition 31 become a resin layer 20 to bond the second substrate 14. Here, when cured, the resin composition 31 becomes a layer portion 32.

As the resin composition 31, for example, the above-mentioned first composition may be applied by using e.g. a dispenser or a die coater. Here, the resin composition 31 is not limited to the above first composition, so long as it is capable of bonding the second substrate 14.

The viscosity of the first composition is preferably from 0.05 to 50 Pa·s, more preferably from 1 to 20 Pa·s. When the viscosity is at least 0.05 Pa·s, the proportion of a low molecular weight monomer can be suppressed, and deterioration of the physical properties of the layer portion 32 can be prevented. Further, a low boiling point component tends to be less, whereby the after-mentioned volatilization in a reduced pressure atmosphere can be reduced, such being desirable. When the viscosity is at most 50 Pa·s, voids tend to be less likely to remain in the layer portion 32.

Then, as shown in FIG. 4(c), the resin composition 31 and the seal portion 30 are subjected to bonding treatment such as thermosetting treatment or photo-curing treatment, and the second substrate 14 is set on the disposition region 12a of the first substrate 12. Here, bonding of the second substrate 14 and the resin layer 20 may be conducted under reduced pressure.

Then, as shown in FIG. 4(d), along the periphery on the surface 14a of the second substrate 14, a seal portion 34 is formed in a frame shape. This seal portion 34 may be formed, for example, in the same manner as for the seal portion 30 shown in FIG. 4(a), using the above-mentioned second composition.

And, in the region surrounded by the seal portion 34, a curable resin composition 35 for forming a layer portion (hereinafter referred to as the resin composition 35) is formed. Here, when cured, the resin composition 35 becomes a layer portion 36.

The resin composition 35 may be formed, for example, by applying the above first composition by using e.g. a dispenser or a die coater. Here, the resin composition 35 may be formed uniformly in the region surrounded by the seal portion 34, or may be formed in a dotted or linear prescribed pattern therein.

Then, as a semi-finished product of the transparent plate 10, one having the resin composition 35 formed on the surface 14a of the second substrate 14 (hereinafter referred to as the laminate) is transported into a reduced pressure chamber 40, as shown in FIG. 4(e). In the reduced pressure chamber 40, the protective film 18 is held as bonded to a support plate 42. This support plate 42 is composed of e.g. a glass plate or a resin plate and disposed above the resin composition 35. Further, in the reduced pressure chamber 40, a known thermosetting treatment apparatus (not shown) or photo-curing treatment apparatus (not shown) may be provided so that thermosetting treatment or photo-curing treatment can be conducted.

To the reduced pressure chamber 40, a vacuum pump (not shown) is connected, and the pressure is reduced to a prescribed level by this vacuum pump.

At the time of laminating the protective film 18 of the support plate 42 on the resin composition 35, the pressure in the reduced pressure chamber 40 is, for example, at most 1 kPa, preferably from 10 to 300 Pa, more preferably from 15 to 100 Pa. If the pressure in the reduced pressure chamber 40 is too low, it is likely to bring about an adverse influence such that various components (such as a curable compound, a photopolymerization initiator, a polymerization inhibitor, a chain transfer agent, a photo-stabilizer, etc.) contained in the resin composition 35 will vaporize, and it takes time to bring the interior of the reduced pressure chamber 40 to the prescribed pressure.

Then, as shown in FIG. 4(e), the support plate 42 is permitted to descend to let the protective film 18 be in contact closely with and be bonded to the seal portion 34 and the resin composition 35.

After bonding the support plate 42 via the protective film 18 to the seal portion 34 and the resin composition 35, the reduced pressure atmosphere in the reduced pressure chamber 40 is released, and the laminate is kept in a pressure atmosphere of at least 50 kPa for a prescribed period of time. At that time, the laminate and the support plate 42 are pressed in a direction for close contact by the raised pressure, whereby if voids are present in the closed space in the laminate, the uncured resin composition 35 flows into the voids, and the entire closed space will be uniformly filled by the resin composition 35.

Here, the pressure in the reduced pressure chamber 40 after having the reduced pressure atmosphere released, is usually from 80 to 120 kPa. However, the pressure in the reduced pressure chamber 40 is most preferably the atmospheric pressure, since it is thereby possible to conduct curing, etc. of the resin composition 35 without requiring any special installation.

The time until the pressure in the reduced pressure chamber 40 is brought to a pressure close to the atmospheric pressure after the time when the protective film 18 of the support plate 42 was laminated on the resin composition 35, is not particularly limited. For example, it may be a long time of at least a few hours, but from the viewpoint of the production efficiency, it is preferably within 1 hour, more preferably within 10 minutes.

The time for keeping the laminate in a pressure atmosphere of at least 50 kPa (hereinafter referred to as the high pressure retention time) is not particularly limited. In a case where the process of taking out the laminate from the reduced pressure apparatus and transferring it to the curing apparatus, followed by initiating curing, is carried out in the atmospheric pressure atmosphere, the time required for the process is the high pressure retention time. Therefore, in a case where voids are no longer present in the closed space of the laminate at the time when placed in the atmospheric pressure atmosphere, or in a case where voids have disappeared in the process, it is possible to immediately cure the resin composition 35. From the viewpoint of the production efficiency, the high pressure retention time is preferably within 6 hours, more preferably within 1 hour, and particularly preferably within 10 minutes, since the production efficiency will be further increased.

Upon expiration of the prescribed time under high pressure, the uncured resin composition 35 and the uncured or semi-cured seal portion 34 are cured to form an adhesive layer 16. At that time, the uncured or semi-cured seal portion 34 may be cured at the same time as curing of the uncured resin composition 35, or may be cured in advance before curing the uncured resin composition 35.

In a case where the resin composition 35 and the uncured or semi-cured seal portion 34 are composed of photo-curable compositions, they may be cured, for example, by applying ultraviolet rays or visible light with a short wavelength of at most 450 nm by using a light source such as an ultraviolet lamp, a high pressure mercury lamp or UV-LED.

Upon curing of the resin composition 35 and the uncured or semi-cured seal portion 34, as shown in FIG. 4(f), a layer portion 36 is formed, and by peeling off the support plate 42 from the protective film 18, a transparent plate 10 having the adhesive layer 16 protected by the protective film 18 will be produced.

The process for producing the transparent plate 10 is not limited to the one shown in FIGS. 4(a) to 4(f), and it may be produced by other production methods.

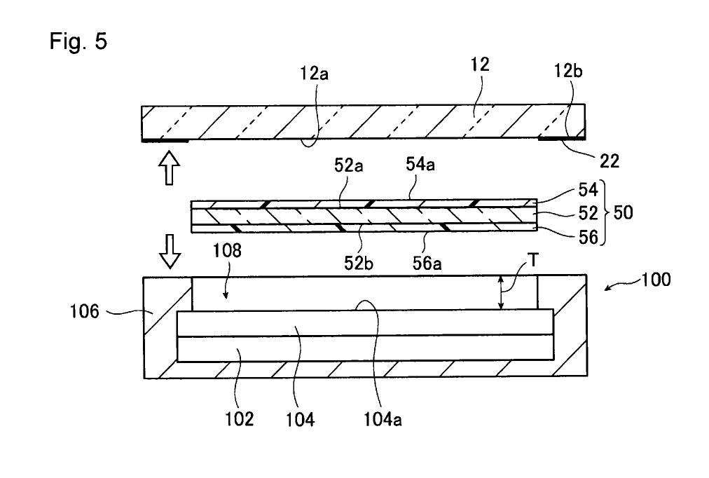

FIG. 5 is a schematic cross-sectional view illustrating another process for producing the transparent plate shown in FIG. 1(a). Here, in FIG. 5, the same constructions as the transparent plate 10 shown in FIGS. 1(a) and 1(b) and the LCD module 100 shown in FIGS. 2(a) and 2(b), are represented by the same symbols, and their detailed description will be omitted.

As shown in FIG. 5, a double-sided adhesive layer-equipped transparent member 50 (hereinafter referred to as the transparent member 50) is used for forming the transparent plate 10. In this case, as the first substrate 12, one having a light-shielding portion 22 formed along the peripheral region 12b, and a LCD module 100, are preliminarily prepared. Here, as the method for forming the light-shielding portion 22, the above-mentioned method (see FIG. 4(a)) may be employed, and therefore, its detailed description will be omitted.

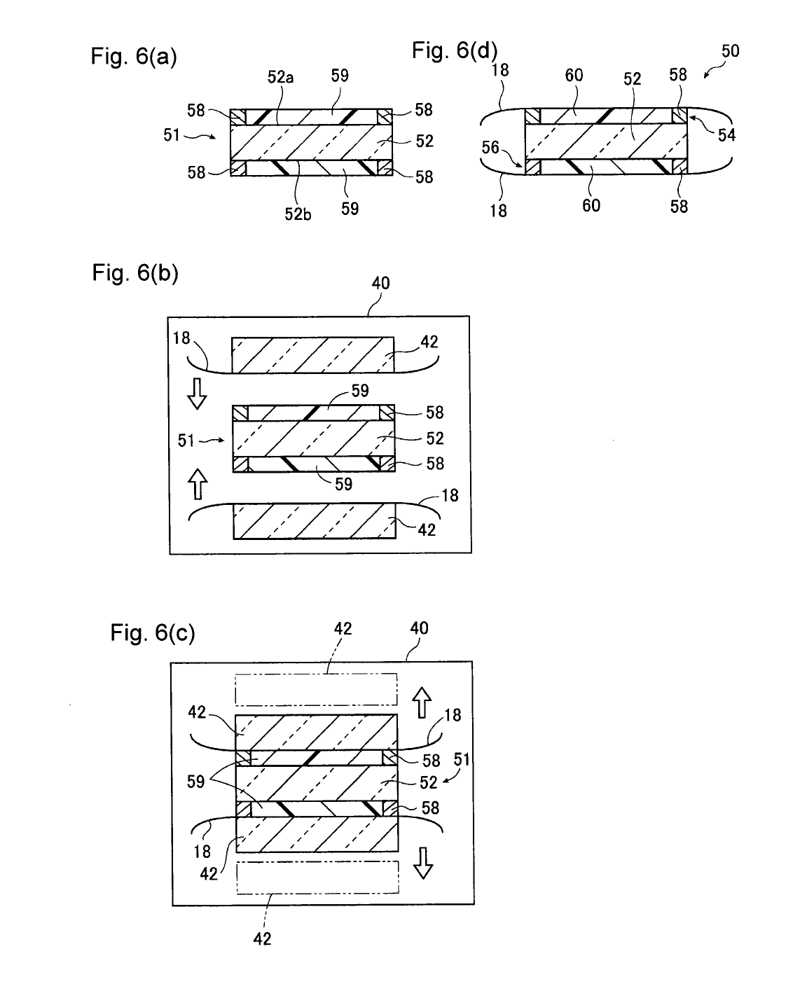

In the LCD module 100, the difference in level of the frame 106 is a distance T. The transparent member 50 is one formed to have its thickness adjusted to the difference in level. The transparent member 50 is one having a first adhesive layer 54 formed on the front surface 52a of a transparent substrate 52 and having a second adhesive layer 56 formed on the rear surface 52b of the transparent substrate 52. The transparent substrate 52 is one corresponding to the second substrate 14 of the transparent plate 10 shown in FIG. 1(a). The first adhesive layer 54 is one corresponding to the resin layer 20 of the transparent plate 10 shown in FIG. 1(a). The second adhesive layer 56 is one corresponding to the adhesive layer 16 of the transparent plate 10 shown in FIG. 1(a). On the front surface of each of the first adhesive layer 54 and the second adhesive layer 56, a protective film 18 (see FIGS. 6(b) and 6(c)) is provided, but it will be peeled off at the time of bonding the transparent plate 10.

Here, the first adhesive layer 54 is constituted by a seal portion 58 (not shown in FIG. 5, see FIG. 6(d)) formed in a frame shape along the periphery of the front surface 52a of the transparent substrate 52 and a layer portion 60 (not shown in FIG. 5, see FIG. 6(d)) formed in the region surrounded by this seal portion 58.

The second adhesive layer 56 is constituted by a seal portion 58 (not shown in FIG. 5, see FIG. 6(d)) formed in a frame shape along the periphery of the rear surface 52b of the transparent substrate 52 and a layer portion 60 (not shown in FIG. 5, see FIG. 6(d)) formed in the region surrounded by this seal portion 58.

Like between the above-described adhesive layer 16 and resin layer 20, as between the first adhesive layer 54 and second adhesive layer 56, the second adhesive layer 56 is preferably made thicker. Further, with respect to the shear modulus at 25° C., the second adhesive layer 56 preferably has a shear modulus lower than the first adhesive layer 54.

By bonding the front surface 54a of the first adhesive layer 54 of the transparent member 50 to the disposition region 12a of the first substrate 12 and bonding the front surface 56a of the second adhesive layer 56 of the transparent member 50 to the display surface 104a of the LCD module 100, it is possible to obtain the transparent plate 10 as shown in FIG. 1(a). Here, the order of bonding the transparent member 50 and the first substrate 12 and bonding the transparent member 50 and the LCD module 100, is not particularly limited, and either one may precede the other, or both may be conducted at the same time.

Now, the process for producing the transparent member 50 will be described.

FIGS. 6(a) to 6(d) are schematic cross-sectional views showing stepwisely a process for producing a double sided adhesive layer-equipped transparent member to be used for the process for producing the transparent plate shown in FIG. 5. Here, in the process for producing the transparent member 50, with respect to the same production apparatus and production steps as in the process for producing the transparent plate 10 shown in the above FIGS. 4(a) to 4(f), their detailed description will be omitted.

As shown in FIG. 6(a), a seal portion 58 is formed in a frame shape along the periphery of the front surface 52a of the transparent substrate 52. This seal portion 58 can be formed by the same method as for the seal portion 30 shown in FIG. 4(d), and therefore, its detailed description will be omitted.

And, a curable resin composition 59 for forming a layer portion (hereinafter referred to as the resin composition 59) is applied to the region surrounded by the seal portion 58. When cured, the resin composition 59 becomes a layer portion 60.

The resin composition 59 may be formed by the same method as for the resin composition 35 shown in FIG. 4(d). Further, the resin composition 59 may be formed uniformly in the region surrounded by the seal portion 58, or may be formed in a dotted or linear prescribed pattern therein.

Further, also on the rear surface 52b of the transparent substrate 52, a seal portion 58 is formed in a frame shape along the periphery of the rear surface 52b in the same manner as on the front surface 52a side, and a resin composition 59 is formed in the region surrounded by this seal portion 58.

As between the resin composition 59 on the front surface 52a side (which will, upon curing, constitute a first adhesive layer 54 together with a seal portion 54) and the resin composition 59 on the rear surface 52b side (which will, upon curing, constitute a second adhesive layer 56 together with seal portion 54), the composition, the shear modulus at 25° C. and the thickness, may be varied. For example, the second adhesive layer 56 may be made to have a smaller shear modulus at 25° C. and/or a thicker layer thickness.

Here, one having the uncured or semi-cured seal portion 58 and the uncured resin composition 59 formed on each side of the transparent substrate 52 will be referred to as an intermediate member 51.

Then, as shown in FIG. 6(b), the intermediate member 51 is transported into a reduced pressure chamber 40, and a protective film 18 bonded to and supported by a support plate 42, is disposed to face against the uncured resin composition 59 at each side. And, the inside of the reduced pressure chamber 40 is vacuumed to a prescribed pressure by a vacuum pump (not shown).

Then, as shown in FIG. 6(c), the support plate 42 is moved towards the intermediate member 51 to bring the protective film 18 in contact closely with the resin composition 59. After bonding the protective film 18 to the resin composition 59, the bonded assembly is kept under high pressure for a prescribed period of time. Thereafter, the uncured resin composition 59 is subjected to a prescribed curing treatment such as thermosetting treatment or photo-curing treatment, whereby the first adhesive layer 54 and the second adhesive layer 56 will be formed (see FIG. 6(d)).

The step of forming the first adhesive layer 54 and the second adhesive layer 56 is the same step as the step of forming the adhesive layer 16 shown in FIG. 4(f), and therefore, its detailed description will be omitted.

After the curing treatment of the resin composition 59, the first adhesive layer 54 and the second adhesive layer 56 have a larger adhesive force to the protective film 18 than the support plate 42. Therefore, when the support plate 42 is moved to depart from the intermediate member 51, there will be such a state that the protective film 18 is attached to each of the first adhesive layer 54 and the second adhesive layer 56.

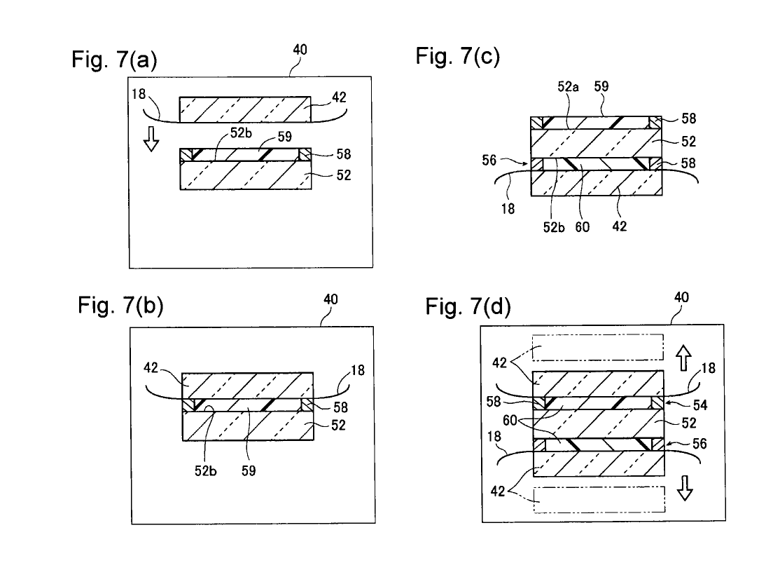

The process for producing the transparent member 50 is not limited to the above process, and it may be produced, for example, by another process shown in FIGS. 7(a) to 7(d). In this case, with respect to the same production apparatus and production steps as for the transparent member 50 shown in FIGS. 6(a) to 6(d), their detailed description will be omitted.

Firstly, as shown in FIG. 7(a), a seal portion 58 is formed in a frame shape along the periphery of the rear surface 52b of a transparent substrate 52, and a resin composition 59 is formed in the region surrounded by this seal portion 58.

And, the assembly is transported into a reduced pressure chamber 40, and a protective film 18 supported by a support plate 42 is disposed above the resin composition 59. And, the inside of the reduced pressure chamber 40 is vacuumed to a prescribed pressure by a vacuum pump (not shown).

Then, as shown in FIG. 7(b), the support plate 42 is moved towards the resin composition 59 on the rear surface 52b side to let the protective film 18 be in contact closely with and bonded to the resin composition 59 on the rear surface 52b side. After bonding the protective film 18 to the resin composition 59, the bonded assembly is kept under high pressure for a prescribed period of time. Thereafter, the resin composition 59 on the rear surface 52b side is subjected to a prescribed curing treatment such as thermosetting treatment or photo-curing treatment, whereby a second adhesive layer 56 will be formed.

After the second adhesive layer 56 is formed, the transparent substrate 52 is taken out in such a state that the support plate 42 is closely in contact. Then, as shown in FIG. 7(c), a seal portion 58 is formed along the periphery of the front surface 52a of the transparent substrate 52, and a resin composition 59 is formed in the region surrounded by this seal portion 58.

Then, as shown in FIG. 7(d), the assembly is transported into a reduced pressure chamber 40, and a protective film 18 bonded to and supported by a support plate 42, is disposed above the resin composition 59 on the front surface 52a side. And, the inside of the reduced pressure chamber 40 is vacuumed to a prescribed pressure by a vacuum pump (not shown).

And, the support plate 42 is moved towards the resin composition 59 on the front surface 52a side to let the protective film 18 be in contact closely with and bonded to the resin composition 59 on the front surface 52a side. After bonding the protective film 18 to the resin composition 59, the bonded assembly is kept under high pressure for a prescribed period of time. Thereafter, the resin composition 59 on the front surface 52a side is subjected to a prescribed curing treatment such as thermosetting treatment or photo-curing treatment, whereby a first adhesive layer 54 will be formed.

After the curing treatment of the resin composition 59, the support plate 42 is moved to depart from each of the first adhesive layer 54 and the second adhesive layer 56. At that time, each of the first adhesive layer 54 and the second adhesive layer 56 has a larger adhesive force to the protective film 18 than the support plate 42, and therefore, there will be such a state that the protective film 18 is attached to each of the first adhesive layer 54 and the second adhesive layer 56.

After moving each support plate 42, the rest is taken out from the reduced pressure chamber 40 to obtain a transparent member 50 as shown in FIG. 6(d).

Further, each of the above-described transparent plates may be one having transparent electrodes constituting a touch panel. In such a case, by bonding the transparent plate to a display device, it is possible to impart a touch panel function to the display device.

The present invention is basically one constructed as described above. In the foregoing, the transparent plate of the present invention and a display device using it have been described in detail, but it should be understood that the present invention is by no means limited to the above-described embodiments, and various improvements or modifications may be made within a range not departing from the concept of the present invention.

### INDUSTRIAL APPLICABILITY

According to the transparent plate of the present invention and the display device using it, even in a case where in a display device, the difference in level between a frame, etc. and a display surface is large, it is possible to effectively protect the display surface, such being useful for display devices provided with various display panels or coordinate input devices.

This application is a continuation of PCT Application No. PCT/JP2014/052698, filed on Feb. 5, 2014, which is based upon and claims the benefit of priority from Japanese Patent Application No. 2013-021662 filed on Feb. 6, 2013. The contents of those applications are incorporated herein by reference in their entireties.

### REFERENCE SYMBOLS

10, 10a, 10b: transparent plate (protective plate), 12: first substrate, 14: second substrate, 16: adhesive layer, 18: protective film, 20: resin layer, 22: light-shielding portion, 24, 52: transparent substrate, 30, 34, 58: seal portion, 31, 35, 59: curable resin composition for forming a layer portion (resin composition), 32, 36, 60: layer portion, 40: reduced pressure chamber, 42: support plate, 50: double-sided adhesive layer-equipped transparent member (transparent member), 51: intermediate member, 100: LCD module (display device), 102: backlight unit, 104: liquid crystal panel, 106: frame

What is claimed is:

1. A transparent plate comprising:
a transparent first substrate,
a transparent second substrate formed on the first substrate and having a shape smaller than the first substrate,
an adhesive layer formed on the second substrate, and
a protective film formed on the adhesive layer.

2. The transparent plate according to claim 1, wherein the second substrate is formed on the first substrate via a resin layer.

3. The transparent plate according to claim 1, wherein the first substrate and the second substrate are directly bonded to each other.

4. The transparent plate according to claim 1, wherein the first substrate and the second substrate are integral with each other.

5. The transparent plate according to claim 1, wherein the shapes of the first substrate and the second substrate are rectangular.

6. The transparent plate according to claim 1, wherein the second substrate is provided with a sensor for detecting an input position made of a transparent conductive film.

7. The transparent plate according to claim 5, wherein the centers of the first substrate and the second substrate match each other.

8. The transparent plate according to claim 1, wherein on the surface of the first substrate, a light shielding portion is formed along the periphery of a region where the second substrate is formed.

9. The transparent plate according to claim 1, wherein the first substrate is a chemically tempered glass plate.

10. The transparent plate according to claim 1, wherein the height from the surface of the first substrate to the surface of the adhesive layer is from 0.8 to 2.3 mm.

11. The transparent plate according to claim 1, wherein the thickness of the second substrate is from 0.5 to 1.5 mm.

12. The transparent plate according to claim 1, which is a transparent plate to be used for a display device wherein an upper surface of a frame formed along the periphery on a display surface side of a display panel of the display device is higher than the display surface, so that a stepped portion is present between the upper surface of the frame and the display surface, and wherein the second substrate has a thickness corresponding to the stepped portion, and a stepped portion formed along the periphery of the first substrate, as the second substrate having a shape smaller than the first substrate is formed on the first substrate, is made to be disposed to match the stepped portion formed between the upper surface of the frame and the display surface.

13. A display device comprising a display panel and the transparent plate as defined in claim 1, so that the adhesive layer of the transparent plate having the protective film peeled off, is bonded to a display surface of the display panel.

14. The display device according to claim 13, wherein an upper surface of a frame formed along the periphery on the display surface side of the display panel of the display device is higher than the display surface, so that a stepped portion is present between the upper surface of the frame and the display surface, and wherein in the transparent plate, the second substrate has a thickness corresponding to the stepped portion, and the transparent plate has a stepped portion formed along a periphery of the first substrate, as the second substrate having a shape smaller than the first substrate is formed on the first substrate, and, as the protective film of the transparent plate peeled off, the adhesive layer of the transparent plate is bonded to the display surface of the display panel so that the stepped portion of the transparent plate matches the stepped portion formed between the upper surface of the frame and the display surface.
